(19) United States
(12) Patent Application Publication
(10) Pub. No.: US 2016/0220334 A1
(43) Pub. Date: Aug. 4, 2016

(54) DENTAL IMPLANT BODY FOR FIVE-IN-ONE IMPLANT SURGERY

(71) Applicant: Chun-Leon Chen, Taipei City 105 (TW)

(72) Inventor: Chun-Leon Chen, Taipei City 105 (TW)

(21) Appl. No.: 14/612,622

(22) Filed: Feb. 3, 2015

(51) Int. Cl. A61C 8/00

(52) U.S. Cl. CPC A61C 8/0092; A61C 8/0025; A61C 8/006

(57) ABSTRACT

A dental implant body for five-in-one implant surgery basically comprises a base portion and a first threaded portion twined with at least one thread. The dental implant body is formed with an unthreaded circular projection on a trailing end of the first threaded portion, a plurality of top-cut grooves radially and uniformly disposed on a top surface of the circular projection, and side-cut grooves, which are connected to the top-cut grooves, respectively, and spirally penetrate through the first threaded portion in set directions. Thus, it is possible to obtain a dental implant body, which can be accurately and rapidly screwed to a predetermined position according to a set angle, relatively increase the proper rate of the five-in-one implant surgery, and contribute to the wide use of the five-in-one implant surgery.

### BACKGROUND OF THE INVENTION

(1) Field of the Invention

The invention relates to a dental implant body, and more particularly to a dental implant body capable of accurately and rapidly screwing to a predetermined position according to a set angle, relatively enhancing the proper rate of the five-in-one implant surgery, and contributing to the wide use of the five-in-one implant surgery.

(2) Description of the Prior Art

As well known in the art, the artificial tooth implant is to embed a dental implant body into an alveolar crest bone of an edentulous region of a patient. After the dental implant body is tightly combined with the patient's gum, artificial teeth are mounted on the dental implant body. The complete artificial tooth implant is composed of a dental implant body, a connection body and an artificial tooth or artificial teeth, wherein the dental implant body, the connection body and the artificial tooth may be combined together by screws and/or adhesive agents to form an artificial substitute capable of replacing a patient's original tooth.

In the mounting period of the typical dental implant body, an osteotomy surgery has to be performed to form a correctly-sized circular hole on the alveolar crest bone so that a dental implant body can be inserted into the circular hole. In the conventional osteotomy surgery period, different sizes of drills are used to drill a cut hole. This may involve utilizing a circular drill bit to flatten the occlusion surface of the alveolar crest bone and to form a position mark of the dental implant body. Then, a set of different sizes of drills is utilized to drill a cut hole having a diameter smaller than the diameter of the dental implant body. For example, if the diameter of the dental implant body is equal to 4.75 mm, then the diameter of the drill is equal to 4.25 mm.

When different drills are utilized to drill a cut hole, a countersink drill is conventionally used to drill this cut hole to have a diameter equal to that of a threaded dental implant body. Then, a conoid is inserted into the cut hole of the threaded dental implant body to form a thread in the alveolar crest bone. Because this conventional method of forming the cut hole needs to use different sizes of drills, the surgery time and difficulty are increased, thereby decreasing the surgical success rate.

Furthermore, the rear half position of the nasal sinus layer may be too thin to support a conventional dental implant body root. The early method for raising the nasal sinus layer relates to the generation of a window to increase the entrance of the maxillary nasal sinus by fracturing the cranium portion. Once the nasal sinus is exposed, a surgeon can take the bone from a patient's hip joint, and implant the bone to the nasal sinus layer. This is deemed as an important surgery, and has to be performed under the general anesthetization in the hospital. Meanwhile, this procedure needs the long treatment period of 8 to 12 months. After the 8 to 12 months, a second surgery is performed to place one or multiple dental implant bodies in the implant bone of the nasal sinus. Thereafter, another treatment period of 6 to 9 months is required before the recovery and the final placement.

In view of this, the present inventor firstly publishes a five-in-one implant surgery of firstly drilling a dental implant hole penetrating through the alveolar crest bone of the top of the tooth groove, wherein the pulse water penetrates into the dental implant hole and cuts the nasal sinus membrane from the alveolar crest bone so that the nasal sinus membrane is separated from the alveolar crest bone. Then, a bone mixture is filled between the nasal sinus membrane and the alveolar crest bone through the dental implant hole so as to increase the thickness of the alveolar crest bone. Thereafter, the dental implant hole can be dug with a hole with a first diameter, and a dental implant body with a thread and a side-cut portion can be placed into the dental implant hole.

After the placement of the dental implant body and after the gum tissue near the alveolar bone of the tooth groove is cut, the vertical transplant of the gum tissue can be performed, the gum tissue on the alveolar bone beside the gum tissue is laterally cut, and the gum tissue is transplanted so that the gum tissue abuts upon the dental implant body.

However, many dentists still adopt the conventional dental implant body in the actual operation process. The thread of the conventional dental implant body is in the structural form of starting from the center of the tip end of the dental implant body and twining around the dental implant body. That is, the dental implant body contacts the alveolar crest bone by its front end or the thread on its surface, so that the dental implant body cannot be accurately screwed and positioned according to the preset angle in the process of screwing the dental implant body into the alveolar crest bone. Thus, most dentists worry about their insufficient skill and afraid to try the five-in-one implant surgery.

### SUMMARY OF THE INVENTION

In view of this, a main object of the invention is to provide a dental implant body, which can be accurately and rapidly screwed to a predetermined position according to a set angle, relatively increase the proper rate of a five-in-one implant surgery, and contribute to the wide use of the five-in-one implant surgery.

A dental implant body for five-in-one implant surgery according to the invention basically comprises a base portion and a first threaded portion twined with at least one thread. The dental implant body is formed with an unthreaded circular projection on a trailing end of the first threaded portion, a plurality of top-cut grooves radially and uniformly disposed on a top surface of the circular projection, and side-cut grooves, which are connected to the top-cut grooves, respectively, and spirally penetrate through the first threaded portion in set directions, wherein a preset distance is held between a trailing end of each of the top-cut grooves and a center of the top surface of the circular projection.

When the dental implant body for five-in-one implant surgery according to the invention is being used, the circular projection may contact the alveolar crest bone on the top of the tooth groove, or even may fit with the dental implant hole pre-drilled on the alveolar crest bone to generate the function of stabilizing the placement angle of the dental implant body. In addition, when the front end of the dental implant body contacts the internal tissue of the alveolar crest bone, the top-cut groove can cut the contacted tissue to achieve the object that the dental implant body can be stably, accurately and rapidly screwed to a predetermined position according to the set angle. Also, under the actions of the top-cut grooves and the side-cut grooves, the spiral pushing effect of pushing the attached bone meal in the set direction can be generated.

Furthermore, the dental implant body is formed with an instrument connection hole, having a set depth and a regular polygonal cross-section, on an end surface of the base portion, and a screw hole having a set depth is formed on a bottom surface of the instrument connection hole.

The dental implant body for five-in-one implant surgery further comprises a second threaded portion between the first threaded portion and the base portion, wherein the second threaded portion follows the first threaded portion, and a pitch of the first threaded portion is relatively larger than a pitch of the second threaded portion.

An outer diameter of the first threaded portion decreases progressively in a direction toward the circular projection.

A spiral direction of each of the side-cut grooves is the same as a spiral direction of the thread of the first threaded portion.

A spiral direction of each of the side-cut grooves is reverse to a spiral direction of the thread of the first threaded portion.

Specifically, the dental implant body for five-in-one implant surgery according to the invention can make the dental implant body be accurately and rapidly screwed to a predetermined position according to the set angle, thereby relatively increasing the proper rate of the five-in-one implant surgery and contributing to the wide application of the five-in-one implant surgery. Of course, the invention may also be used in the conventional implant surgery, and can similarly obtain the effect of accurately and rapidly screwing the dental implant body to the predetermined position according to the set angle. When the first threaded portion of the dental implant body is being screwed to the alveolar crest bone, the bone meal tissue, generated by the cutting action, can be pushed toward the outside of the alveolar crest bone under the actions of the top-cut groove and the side-cut groove, thereby contributing to the rapid screwing of the dental implant body to the predetermined position of the alveolar crest bone, or the bone meal tissue, generated by the cutting action, can be pushed toward the inside of the alveolar crest bone to obtain the effect of filling the bone meal. Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a pictorial exterior view showing a dental implant body for five-in-one implant surgery according to a first embodiment of the invention.

FIG. 2 is a structural side view showing the dental implant body for five-in-one implant surgery according to the first embodiment of the invention.

FIG. 3 is a cross-sectional structure view showing the dental implant body for five-in-one implant surgery according to the first embodiment of the invention.

FIG. 4 is a top structure view showing the dental implant body for five-in-one implant surgery according to the first embodiment of the invention.

FIG. 5 is a top structure view showing a dental implant body for five-in-one implant surgery according to a second embodiment of the invention.

FIG. 6 is a top structure view showing a dental implant body for five-in-one implant surgery according to a third embodiment of the invention.

### DETAILED DESCRIPTION OF THE PREFERRED EMBODIMENTS

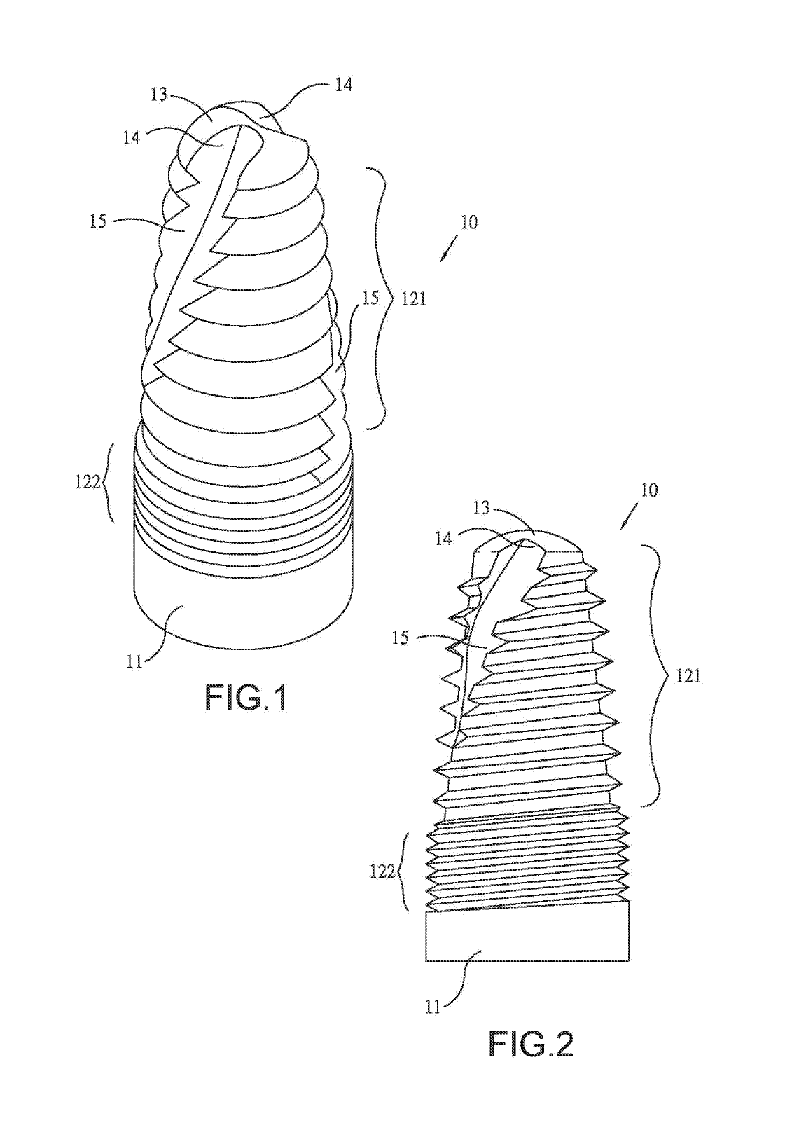

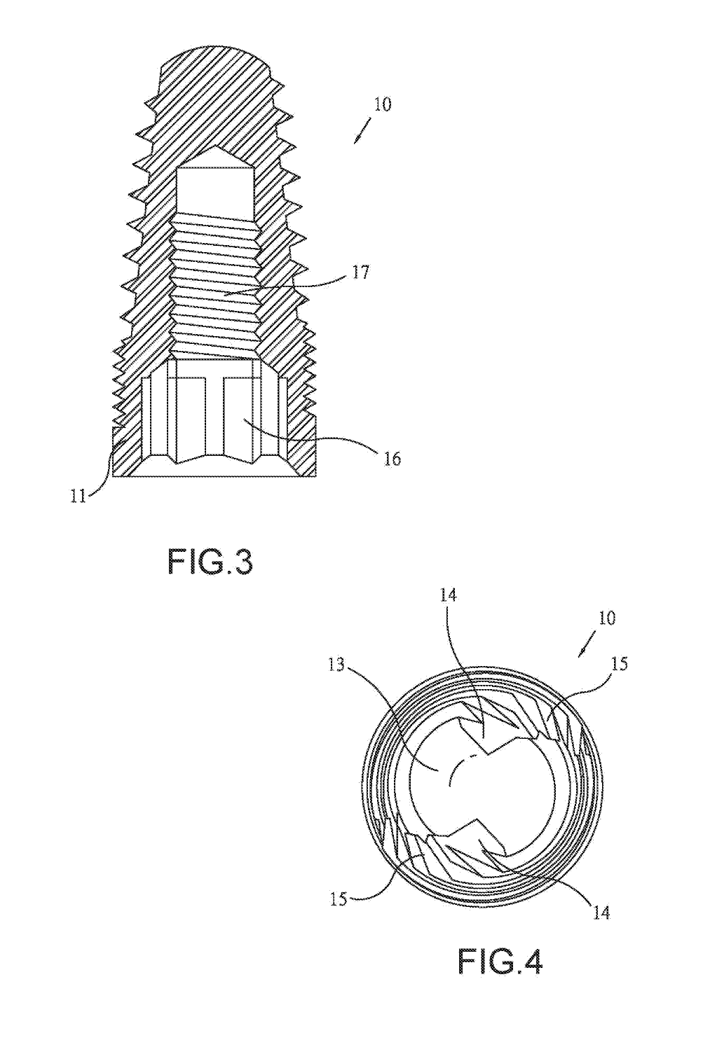

The invention mainly provides a dental implant body, which can be accurately and rapidly screwed to a predetermined position according to a set angle, relatively increase the proper rate of a five-in-one implant surgery, and contribute to the wide use of the five-in-one implant surgery. Referring to FIGS. 1 to 4, the dental implant body 10 for five-in-one implant surgery according to the invention basically has a base portion 11 and a first threaded portion 121 twined with at least one thread.

The dental implant body 10 is formed with an unthreaded circular projection 13 on a trailing end of the first threaded portion 121, a plurality of top-cut grooves 14 radially and uniformly disposed on a top surface of the circular projection 13, and side-cut grooves 15, which are connected to the top-cut grooves 14 and spirally penetrate through the first threaded portion 121 in set directions. A preset distance is held between the trailing end of each top-cut groove 14 and a center of the top surface of the circular projection 13.

Upon implementation, the spiral direction of each side-cut groove 15 is the same as the spiral direction of the thread of the first threaded portion 121. Of course, the spiral direction of each side-cut groove 15 may also be reverse to the spiral direction of the thread of the first threaded portion 121.

Furthermore, upon implementation, the dental implant body 10 for five-in-one implant surgery according to the invention may be formed with an instrument connection hole 16, having a set depth and a regular polygonal cross-section, on an end surface of the base portion 11, so that the dental implant body 10 is fit with a pneumatic wrench (pneumatic dental implant handheld tool) and the dental implant body 10 is embedded into the alveolar crest bone. Furthermore, a screw hole 17 having a set depth may be formed on a bottom surface of the instrument connection hole 16. Thus, after the dental implant body 10 is embedded into the alveolar crest bone and positioned, a bolt can be utilized to mount the artificial teeth on the dental implant body 10.

When the dental implant body 10 for five-in-one implant surgery according to the invention is being used, the circular projection 13 may contact the alveolar crest bone on the top of the tooth groove, or even may fit with the dental implant hole pre-drilled on the alveolar crest bone to generate the function of stabilizing the placement angle of the dental implant body. In addition, when the front end of the dental implant body 10 contacts the internal tissue of the alveolar crest bone, the top-cut groove 14 can cut the contacted tissue to achieve the object that the dental implant body 10 can be stably, accurately and rapidly screwed to a predetermined position according to the set angle.

More particularly, when the first threaded portion 121 of the dental implant body 10 is screwed into the alveolar crest bone, under the actions of the top-cut grooves 14 and the side-cut grooves 15, the spiral pushing effect of pushing the attached bone meal in the set direction can be generated. For example, when the spiral direction of each side-cut groove 15 is the same as the spiral direction of the thread of the first threaded portion 121, the bone meal tissue, generated by the cutting action, can be pushed toward the outside of the alveolar crest bone, thereby contributing to that the dental implant body is rapidly screwed to the predetermined position of the alveolar crest bone. When the spiral direction of each side-cut groove 15 is reverse to the spiral direction of the thread of the first threaded portion 121, the bone meal tissue, generated by the cutting action, can be pushed toward the inside of the alveolar crest bone, thereby achieving the effect of filling the bone meal.

It is to be noted that when the dental implant body for five-in-one implant surgery according to the invention is implemented, the dental implant body may further comprise a second threaded portion 122 between the first threaded portion 121 and the base portion 11. The second threaded portion 122 follows the first threaded portion 121. The pitch of the first threaded portion 121 is relatively larger than the pitch of the second threaded portion 122, and an outer diameter of the first threaded portion 121 preferably decreases progressively in the direction toward the circular projection 13.

The first threaded portion 121 may be connected to the alveolar crest bone in the relatively deep layer of the tissue, and the second threaded portion 122 may be connected to the cortical bone in the relatively shallow layer, so that the more stable and reliable connection effects can be obtained, and the speed of embedding the dental implant body 10 into the alveolar crest bone can be increased.

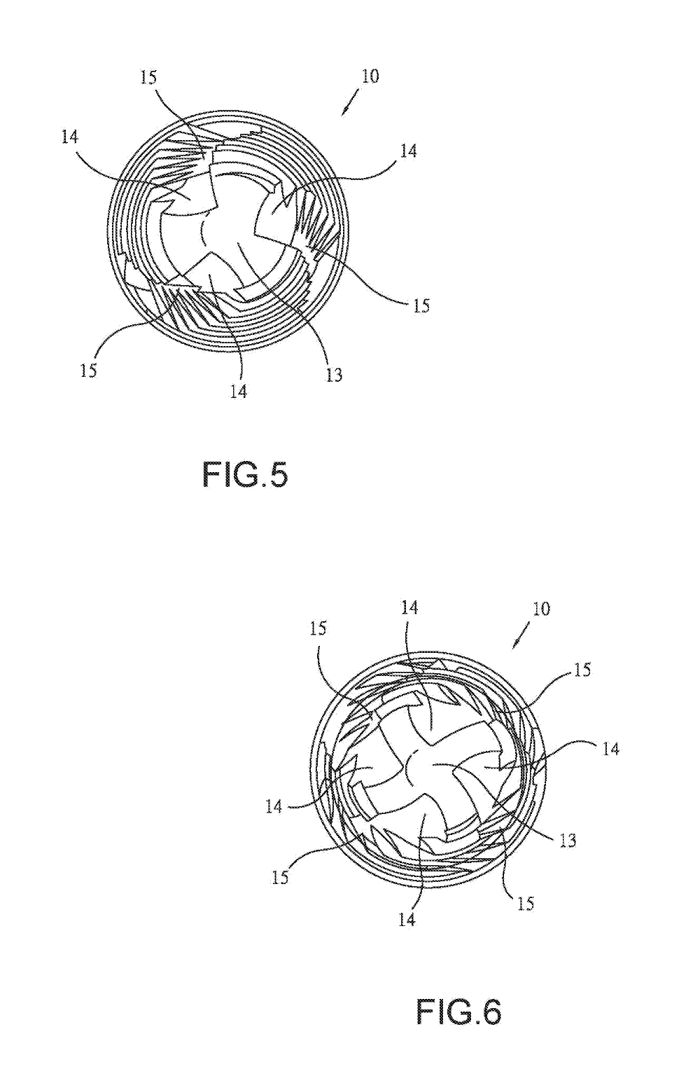

In principle, the dental implant body for five-in-one implant surgery according to the invention can make the rotating dental implant body obtain the stabler balancing effect through the above-mentioned structure design, and generate the better cutting action, and is thus suitable for all portions of the full mouth. Of course, the suitable diameter may also be designed with different application positions and functions. Correspondingly, as shown in FIGS. 5 and 6, the numbers of the top-cut groove(s) 14 and side-cut groove(s) 15 may be properly adjusted according to the diameter change of the whole dental implant body, so that the desired cutting effect can be obtained. Furthermore, no matter what the numbers of the top-cut groove(s) 14 and side-cut groove(s) 15 are, the set distance is preferably held between the trailing end of each top-cut groove 14 and the center of the top surface of the circular projection 13 in order to maintain the reliable structural strength.

Compared with the conventional structure, the dental implant body for five-in-one implant surgery according to the invention can make the dental implant body be accurately and rapidly screwed to a predetermined position according to the set angle, thereby relatively increasing the proper rate of the five-in-one implant surgery and contributing to the wide application of the five-in-one implant surgery. Of course, the invention may also be used in the conventional implant surgery, and can similarly obtain the effect of accurately and rapidly screwing the dental implant body to the predetermined position according to the set angle. When the first threaded portion of the dental implant body is being screwed to the alveolar crest bone, the bone meal tissue, generated by the cutting action, can be pushed toward the outside of the alveolar crest bone under the actions of the top-cut groove and the side-cut groove, thereby contributing to the rapid screwing of the dental implant body to the predetermined position of the alveolar crest bone, or the bone meal tissue, generated by the cutting action, can be pushed toward the inside of the alveolar crest bone to obtain the effect of filling the bone meal.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A dental implant body for five-in-one implant surgery, comprising a base portion and a first threaded portion twined with at least one thread, wherein:
the dental implant body is formed with an unthreaded circular projection on a trailing end of the first threaded portion, a plurality of top-cut grooves radially and uniformly disposed on a top surface of the circular projection, and side-cut grooves, which are connected to the top-cut grooves, respectively, and spirally penetrate through the first threaded portion in set directions, wherein a preset distance is held between a trailing end of each of the top-cut grooves and a center of the top surface of the circular projection.

2. The dental implant body according to claim 1, wherein the dental implant body is formed with an instrument connection hole, having a set depth and a regular polygonal cross-section, on an end surface of the base portion, and a screw hole having a set depth is formed on a bottom surface of the instrument connection hole.

3. The dental implant body according to claim 1, further comprising a second threaded portion between the first threaded portion and the base portion, wherein the second threaded portion follows the first threaded portion, and a pitch of the first threaded portion is relatively larger than a pitch of the second threaded portion.

4. The dental implant body according to claim 2, further comprising a second threaded portion between the first threaded portion and the base portion, wherein the second threaded portion follows the first threaded portion, and a pitch of the first threaded portion is relatively larger than a pitch of the second threaded portion.

5. The dental implant body according to claim 3, wherein an outer diameter of the first threaded portion decreases progressively in a direction toward the circular projection.

6. The dental implant body according to claim 1, wherein a spiral direction of each of the side-cut grooves is the same as a spiral direction of the thread of the first threaded portion.

7. The dental implant body according to claim 2, wherein a spiral direction of each of the side-cut grooves is the same as a spiral direction of the thread of the first threaded portion.

8. The dental implant body according to claim 1, wherein a spiral direction of each of the side-cut grooves is reverse to a spiral direction of the thread of the first threaded portion.

9. The dental implant body according to claim 2, wherein a spiral direction of each of the side-cut grooves is reverse to a spiral direction of the thread of the first threaded portion.
